(19) United States
(12) Patent Application Publication
(10) Pub. No.: US 2006/0068911 A1
(43) Pub. Date: Mar. 30, 2006

(54) Game console communication with a computer

(75) Inventors: Christopher M. Pirich, Seattle, WA (US); Derek H. Smith, Snohomish, WA (US); Gregory A. Martinez, Seattle, WA (US); James E. Yagelowich, Kirkland, WA (US); Jon Marcus Randall Whitten, Sammamish, WA (US); Maciej Maciesowicz, Duvall, WA (US); Mark D. McCracken, Redmond, WA (US); Michael Cory Maston, Sammamish, WA (US); Andrew Murphy, Seattle, WA (US)

Correspondence Address: WOODCOCK WASHBURN LLP, ONE LIBERTY PLACE, 46TH FLOOR, 1650 MARKET STREET, PHILADELPHIA, PA, 19103, US

(73) Assignee: Microsoft Corporation, Redmond, WA (US)

(21) Appl. No.: 10/954,684

(22) Filed: Sep. 30, 2004

(51) Int. Cl. G06F 19/00; G06F 17/00

(52) U.S. Cl. 463/40

(57) ABSTRACT

Communication between a game console having a communication port and a personal computer is facilitated by implementing a shared folder on the personal computer that can be accessed via the communication port. The game console and personal computer may communicate via a Server Message Block compatible code, a Universal Plug and Play networking protocol, and the like. To save memory, the SMB compatible code (or other code) may not support the full set of SMB protocol features (or other protocol features).

### FIELD OF THE INVENTION

The invention generally relates to the field of game consoles. In particular, the invention relates to communication between a game console and a computer.

### BACKGROUND OF THE INVENTION

Traditionally, game consoles were standalone systems that accommodated a limited number of players, such as 1-4 players, that remain local to the game console. A recent trend in game consoles is to provide capabilities to facilitate gaming among multiple players over a network, such as Internet-based online gaming. These online game consoles allow players to compete with other players, regardless of their geographic location by networking multiple game consoles. Beyond the limited trend towards online gaming, game consoles have been provided with little connectivity to other devices.

### SUMMARY OF THE INVENTION

The following is a summary to provide a basic understanding of some aspects of the invention. This summary is not intended as an extensive overview of the invention, nor is it intended to identify key elements of the invention or to delineate the scope of the invention. Its sole purpose is to present some aspects of the invention in a simplified form as a prelude to the more detailed description presented below.

Communication between a game console having a communication port and a computer is facilitated by a shared folder on the personal computer. The personal computer may execute a configuration wizard that interfaces with a user to implement configuration of the shared folder although the personal computer may use any configuration technique. The personal computer may share the folder with the game console in accordance with various protocols or standards, such as, for example, the Server Message Block (SMB) file sharing protocol, and the like. The game console may communicate with the portable computer via an SMB compatible code, negotiation protocol, negotiation dialect, and the like. To save memory, the SMB compatible code (or other code) may not support the full set of SMB protocol features (or other protocol features). For example, the SMB compatible code may not support printing functionality and the like. Further, the game console may communicate with the personal computer via a Universal Plug and Play networking protocol and the game console may function as a Universal Plug and Play networking protocol control point. The communication port may be a network interface port and the like.

An ancillary application executing on the game console may handle the communication between the game console and the personal computer. Alternatively, the game console may execute a primary application (e.g., a game application or a multimedia application) that handles the communication between the game console and the personal computer. The game application or multimedia application may execute in a reserved predetermined amount of hardware resources of the game console while the ancillary application may execute concurrently using the remaining hardware resources. Further, the game application or multimedia application may execute as the primary application and have access to all of the hardware resources of the game console.

Communication with the personal computer may implement various applications. For example, such communication may allow the game console user to store and retrieve game application configuration settings, game controller configuration settings, and game-related information to and from the computer. In this manner, a user may store a saved game, a “left-handed” controller configuration, an inverted controller configuration, and the like, to the computer for possible uploading at another time. The communication may also allow the game console user to store and retrieve multimedia files to and from the computer. In this manner, a user may connect their computer to the game console and play the multimedia files via the game console rather than via the computer.

Additional features of the invention will be made apparent from the following detailed description of illustrative embodiments that proceeds with reference to the accompanying drawings.

### BRIEF DESCRIPTION OF THE DRAWINGS

The foregoing summary, as well as the following detailed description of illustrative embodiments, is better understood when read in conjunction with the appended drawings. For the purpose of illustrating the invention, there is shown in the drawings illustrative embodiments of the invention; however, the invention is not limited to the specific methods and instrumentalities disclosed. In the drawings:

FIG. 1 is a block diagram showing an illustrative game console in which aspects of the invention may be implemented;

FIG. 2 is a diagram showing the illustrative game console of FIG. 1 connected to various exemplary personal computers, each of which are in communication with a network, in accordance with aspects of the invention;

FIG. 3 is a diagram showing the illustrative game console of FIG. 1 in communication with various exemplary personal computers via a network, in accordance with aspects of the invention;

FIG. 4 is a diagram showing a plurality of illustrative game consoles in communication with various exemplary personal computers via a network, in accordance with aspects of the invention;

FIG. 5 is a flowchart of an illustrative method for setting up a communication session between a game console and a personal computer, in accordance with an aspect of the invention;

FIG. 6 is a flowchart of an illustrative method for setting up a shared folder between a game console and a personal computer, in accordance with an aspect of the invention;

FIG. 7 is a flowchart of an illustrative method for communicating multimedia files between a game console and a personal computer, in accordance with an aspect of the invention;

FIG. 8 is a flowchart of an illustrative method for communicating game-related information between a game console and a personal computer, in accordance with an aspect of the invention;

FIG. 9 is a flowchart of another illustrative method for communicating game-related information between a game console and a personal computer, in accordance with an aspect of the invention;

FIG. 10 is a flowchart of yet another illustrative method for communicating game-related information between a game console and a personal computer, in accordance with an aspect of the invention;

FIG. 11 is a screen shot of an illustrative user interface communicating game-related information between a game console and a personal computer, in accordance with an aspect of the invention; and

FIG. 12 is a screen shot of another illustrative user interface communicating game-related information between a game console and a personal computer, in accordance with an aspect of the invention.

### DETAILED DESCRIPTION OF ILLUSTRATIVE EMBODIMENTS

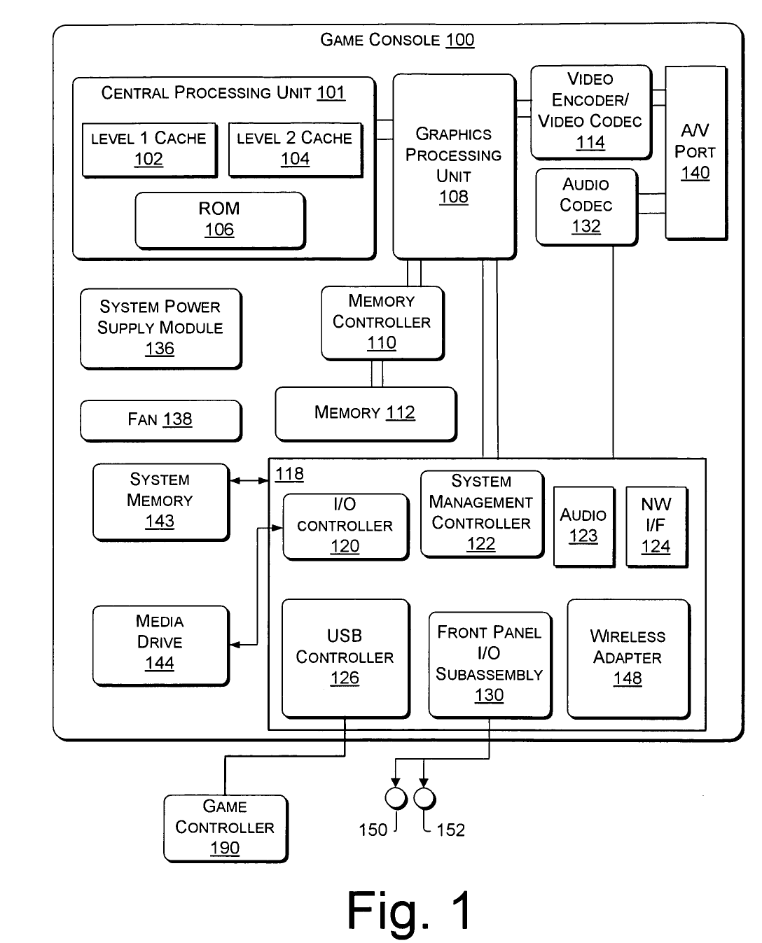

FIG. 1 illustrates the functional components of a game console 100 with which aspects of the invention may be implemented. The game console 100 has a central processing unit (CPU) 101 having a level 1 (L1) cache 102, a level 2 (L2) cache 104, and a flash ROM (Read-only Memory) 106. The L1 cache 102 and L2 cache 104 temporarily store data and hence reduce the number of memory access cycles, thereby improving processing speed and throughput. The flash ROM 106 may store executable code that is loaded during an initial phase of a boot process when the game console 100 is powered.

A graphics processing unit (GPU) 108 and a video encoder/video codec (coder/decoder) 114 form a video processing pipeline for high speed and high resolution graphics processing. Data is carried from the graphics processing unit 108 to the video encoder/video codec 114 via a bus. The video processing pipeline outputs data to an A/V (audio/video) port 140 for transmission to a user interface, such as, for example, a television or other display. A memory controller 110 is connected to the GPU 108 and CPU 101 to facilitate processor access to various types of memory 112, such as, but not limited to, a RAM (Random Access Memory).

The game console 100 includes an I/O controller 120, a system management controller 122, an audio processing unit 123, a network interface controller 124, a Universal Serial Bus (USB) host controller 126, and a front panel I/O subassembly 130 that are preferably implemented on a module 118. While one USB controller 126 is shown in FIG. 1, there may be two, three, or any number of USB controllers. USB controller 126 may be used to communicate with a personal computer, and the like, as described in more detail below. USB controllers 126 includes a USB ports for connection to a variety of USB compatible devices.

The network interface controller 124 provides access to a network (e.g., the Internet, home network, and the like) and may be any of a wide variety of various wired or wireless interface components including an Ethernet card, a modem, a Wi-Fi Module, a Bluetooth module, a cable modem, and the like.

Game console 100 may communicate with game controller 190 via USB controller 126, as shown in FIG. 1. Game controller 190 typically functions as an input device to game console 100 whereby a user may input information into game console 100 via the game controller 190 while “playing” a game application. Game controller 190 may include a gamepad, buttons, and the like.

System memory 143 stores application data that is loaded during the boot process. A media drive 144 is provided and may comprise a DVD/CD drive, hard drive, or other removable media drive, and the like. Application data may be accessed via the media drive 144 for execution, playback, etc. by the game console 100. The media drive 144 is connected to the I/O controller 120 via a bus, such as a Serial ATA bus or other high speed connection (e.g., IEEE 1394).

The system management controller 122 provides a variety of service functions related to assuring availability of the game console 100. The audio processing unit 123 and an audio codec 132 form a corresponding audio processing pipeline with high fidelity and stereo processing. Audio data is carried between the audio processing unit 123 and the audio codec 126 via a communication link. The audio processing pipeline outputs data to the A/V port 140 for reproduction by an external audio player or device having audio capabilities.

The front panel I/O subassembly 130 supports the functionality of the power button 150 and the eject button 152, as well as any LEDs (light emitting diodes) or other indicators exposed on the outer surface of the game console 100. A system power supply module 136 provides power to the components of the game console 100. A fan 138 cools the circuitry within the game console 100.

The CPU 101, GPU 108, memory controller 110, and various other components within the game console 100 are interconnected via one or more buses, including serial and parallel buses, a memory bus, a peripheral bus, and a processor or local bus using any of a variety of bus architectures.

When the game console 100 is powered on or rebooted, application data may be loaded from the system memory 143 into memory 112 and/or caches 102, 104 and executed on the CPU 101. The application may present a graphical user interface that provides a consistent user experience when navigating to different media types available on the game console 100. In operation, game applications, other multimedia applications, and/or other media contained within the media drive 144 may be launched or played from the media drive 144.

The game console 100 may be operated as a standalone system by connecting the system to a television or other display. In this standalone mode, the game console 100 allows one or more local users to interact with the system and play game applications. However, with the integration of broadband connectivity made available through network interface 124 or the wireless adapter 148, the game console 100 may further be operated as a participant in a larger network community of interconnected game consoles.

Because of the high processing demand of gaming applications, game console 100 typically dedicates a large percentage of processing time and resources to the gaming application and distributes the remaining processing time and resources to other applications, such as communicating with a personal computer or network connected to USB controllers 126, 128, network interface controller 124, and the like. Alternatively, game console 100 may dedicate or reserve a small percentage of processing time and resources to ancillary applications, leaving the remaining processing time and resources to the gaming application. Further, game console 100 may dedicate or reserve separate processing time and resources for both the gaming application and the ancillary applications.

Game console 100 (or any other multimedia console that dedicates a percentage of processing time and resources to a multimedia application) may allow a game application to retain substantial control over the hardware resources of the game console 100, so that game developers can rely on having a certain amount of processing time and resources. For example, game console 100 may reserve a predetermined amount of game console hardware resources for game applications while the remainder of hardware resources are controlled by other applications (such as communicating with a personal computer). In this manner, the game application retains substantial control over hardware resources, unlike applications executing in conventional personal computing (PC) operating systems which have little control over hardware resources. As such, game applications do not need to directly support ancillary functionalities. Instead, such ancillary functionalities may be implemented in the remaining (non-dedicated) hardware resources of game console 100.

In order to present a consistent, unchanging resource usage signature for the game applications, a number of different game console resources may be managed. These various resources may include the CPU 101, cache memory 102, 104, main memory 112, audio channels, game controller input, and the like. For example, an operating system kernel of the game console 100 may reserve resources for game applications. The operating system kernel may reserve a predetermined amount of memory for game applications and typically does not make this reserved memory available to the other applications. The kernel, drivers, and any other game-related code, including the game application, may reside in this reserved memory. If the game application requires less than the full amount of available dedicated memory, the kernel typically still allocates and reserves the predetermined amount of memory so that the game application sees a consistent amount of available memory. In particular, the memory reservation may leave enough remaining memory to contain the launch kernel and drivers. Typically, this reservation allows enough remaining resources for new ancillary applications and drivers over the life of the game console 100, as well as any anticipated expansion in the size of the ancillary applications and driver footprints.

Further, the operating system kernel may reserve a second predetermined amount of memory for use in communication between the game application and the ancillary applications. Such communication may occur, for example, when an ancillary application receives a user request that should cause some action to occur in the game application. For example, if an ancillary application receives a request to display a digital picture, this may typically cause the game application to pause. This second predetermined amount of memory can be used to transmit information to the game application, causing the game application to pause.

The operating system kernel may also reserve a predefined number of audio channels (monophonic streams) for use by ancillary applications (e.g., ten audio channels may be reserved out of roughly 300 available channels in a typical game console 100).

The operating system kernel loads drivers that may include a GPU driver that sets up an interrupt. The interrupt may be a GPU interrupt, such as, for example, a programmable scan line interrupt that generates an interrupt when the video output reaches a predetermined scan line on the video display or may be another suitable interrupt source. The GPU interrupt may be used to keep in synch with the GPU video frame and ancillary applications may be scheduled in response to a scan line interrupt from the GPU.

Game console 100 may also include an MP3 decoder, a WMA decoder, and the like for decoding audio (e.g., music) files or other files. The operating system kernel may load decoders and the like into memory upon startup or power-up of game console 100 or the decoders may be loaded into memory when their functionality is desired by another application.

In a multiprocessor game console, the reservation of CPU time (e.g., implemented via interrupts or other techniques) may be distributed among the CPUs in various fashions. For example, the game application may be executed on a first CPU (and may also be executed on the other CPUs) with no ancillary applications being executed on the first CPU. Ancillary applications may be scheduled at times on the other CPUs. Ancillary applications may be scheduled for X% of CPU processing time on a second CPU and Y% of CPU processing time on a third CPU. Further, the X% and Y% of processing time may be scheduled at the end of processing a video frame. The X% and Y% of processing time may be equal (i.e., symmetric) or non-equal (i.e., asymmetric). Further, the determinations of the X% and Y% of processing time may be based on design requirements for ancillary applications.

Both the game application and the ancillary application may expect to receive user input, however, conventional game applications have complete control over user input (e.g., via game controller 190, “gamepad” input). Game console 100, however, appropriately manages or shares the user input (e.g., game controller 190 input) between the game application and the ancillary applications. Typically, game applications are not aware of when they lose user input focus from the game controller 190 to an ancillary application or when it is restored back to the game application. Therefore, gamepad state (e.g., what game controller 190 buttons are pressed) is maintained when user input focus is switched between the game application and the ancillary application. Further, the state set on the gamepad in the game application, while the game application does not have the input focus, may be queued and maintained until the user input focus is returned to the game application. For example, if the game application sets a gamepad vibration state (e.g., a state in which a vibration generating motor runs in the gamepad to cause the gamepad itself to vibrate) while the ancillary application has the user input focus, this vibration state is queued (and updated) to be consistent when the user input focus is restored to the game application. The input devices are not reserved resources, but are switched between the game application and the ancillary application such that each will have the appropriate focus of the device. An application manager may control the switching of input stream, without the game application's knowledge, and a driver may maintain state information regarding focus switches. Other types of user interaction are possible, such as pausing the game application when the user interacts with an ancillary application, etc.

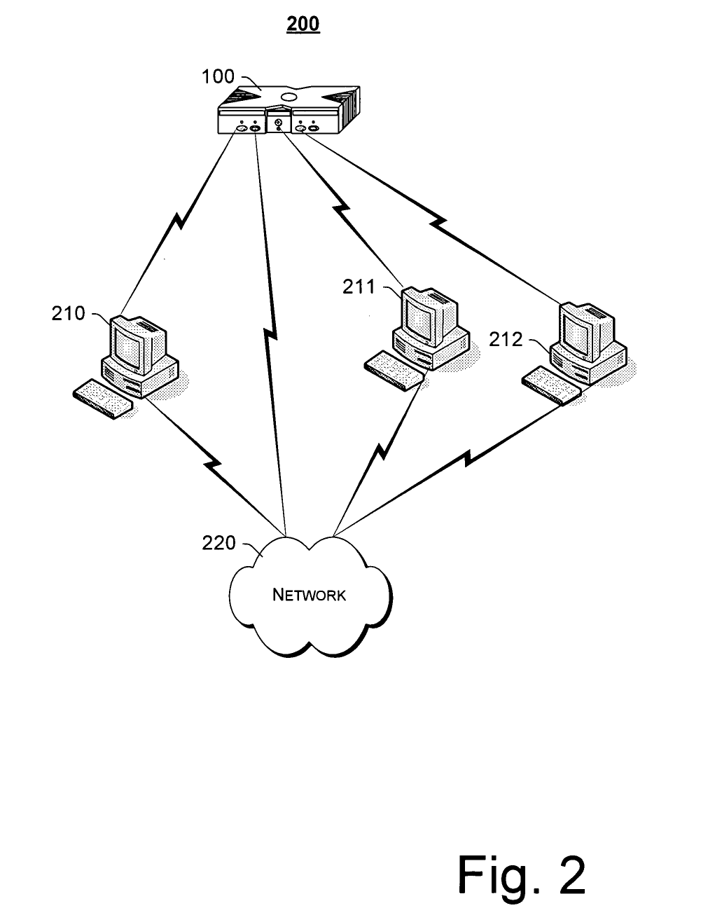

FIG. 2 is a diagram showing the illustrative game console of FIG. 1 connected to various exemplary personal computers. As shown in FIG. 1, game console 100 is connected to a first personal computer 210, a second personal computer 211, and a third personal computer 212. Each personal computer 210, 211, 212 can be connected to game console 100 in a variety of ways. For example, personal computer 210 may be connected to network interface controller 124, personal computer 211 may be connected to USB controller 126 via a wireless modem (not shown), personal computer 212 may be connected to wireless adapter 148, and the like. Each personal computer 210 may be in communication with network 220, which may be the Internet, a local area network, a wide area network, a WiFi network, a Bluetooth network, a wireless network, and the like. Moreover, the game console 100 may be in communication with network 220. Either the game application, the ancillary application, or other application (possibly in combination with other code, e.g., drivers and the like) may implement the communication between the game console and the personal computer.

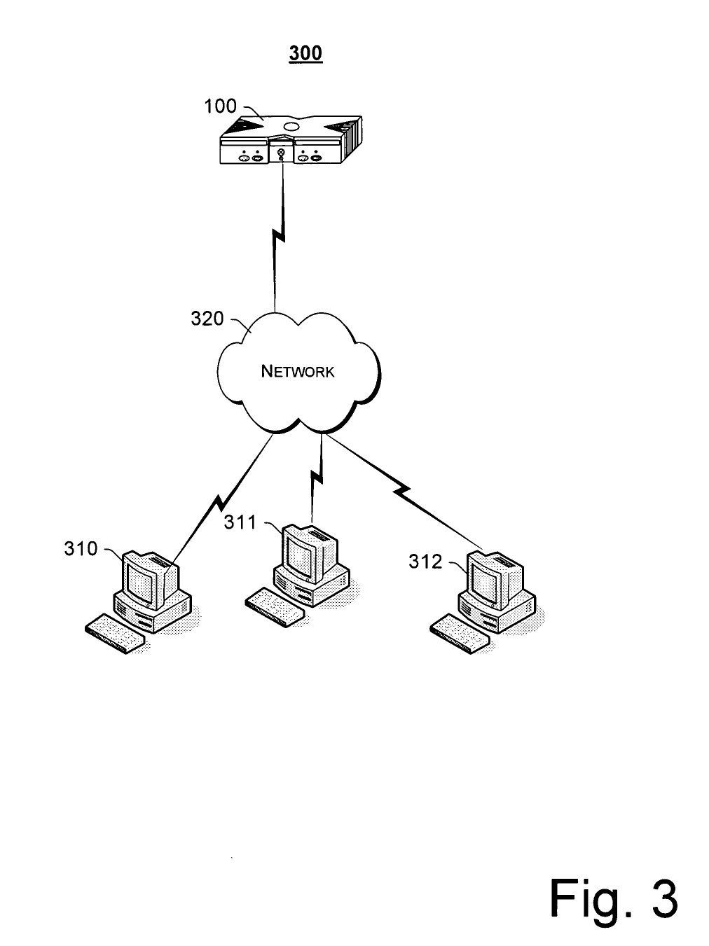

FIG. 3 is a diagram showing the illustrative game console of FIG. 1 connected to various exemplary personal computers via a network. As shown in FIG. 3, game console 100 is in communication with a network 320, which is in turn in communication with a first personal computer 310, a second personal computer 311, and a third personal computer 312. In such a configuration as in FIG. 3, network 320 is typically a home network or the like; however, network 320 may be any network.

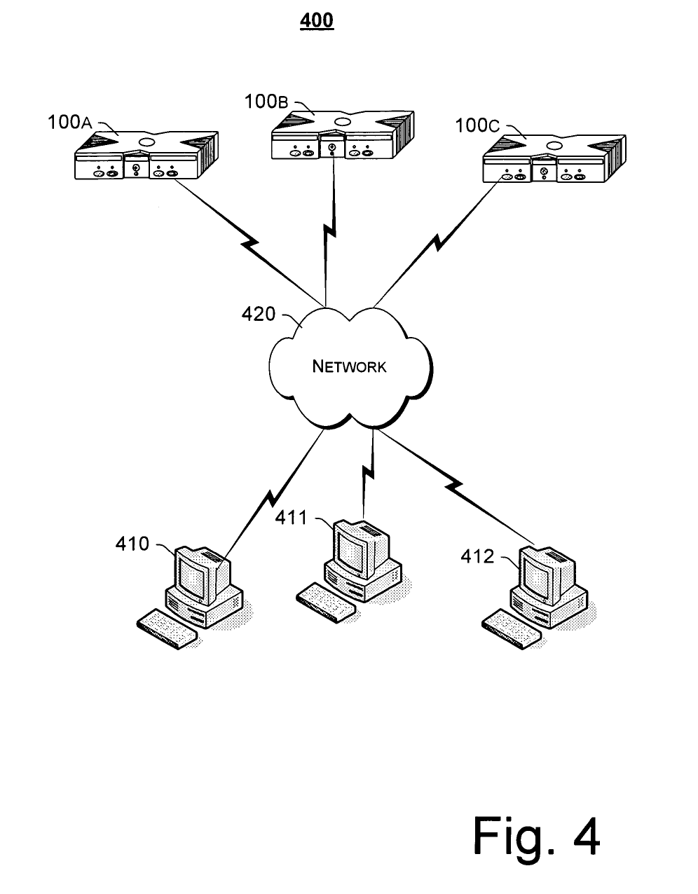

FIG. 4 is a diagram showing a plurality of illustrative game consoles 100A, 100B, 100C in communication with various exemplary personal computers via a network. As shown in FIG. 4, game consoles 100A, 100B, and 100C are in communication with a network 420, which is in turn in communication with a first personal computer 410, a second personal computer 411, and a third personal computer 412. In such a configuration as in FIG. 4, network 420 is typically a subnet, such as found in a dormitory, or the like; however, network 420 may be any network.

The game console 100 and variety of personal computers (e.g., see FIG. 2) may communicate in accordance with a variety of protocols or standards, such as, for example, the Server Message Block (SMB) file-sharing protocol, a proprietary protocol, and the like. Game console 100 may support many protocols, a single protocol, or any combination of protocols. For example, game console 100 may support only the SMB protocol. Alternatively, game console 100 may support the SMB protocol and a single proprietary protocols. Further, game console 100 may support multiple proprietary protocols so that many personal computers using various proprietary protocols may communicate with game console 100. The SMB compatible code may or may not include support for Unicode. Providing such support may be useful for enhanced authentication techniques, but typically increases the size of the SMB compatible code.

Game console 100 may provide support for particular protocols by implementing a driver (consistent with the particular protocol) that is used to communicate between the game console 100 (e.g., an ancillary application of game console 100) and a personal computer. The drivers are typically associated with only a single protocol, however, the drivers may be associated with multiple protocols (and thus be able to communicate in accordance with multiple protocols). The drivers may be stored in system memory 143, in ROM 106, in media drive 144, or the like.

A driver may support only a portion of a particular protocol in order to conserve memory consumption in game console 100. That is, in order to reduce the amount of memory reserved for communication between the game console and the personal computer, the driver may not support the full set of functionalities for a protocol, but may only support a subset of the protocol's functionalities. These non-supported functionalities are typically functionalities that are not critical or are not related to a desired functionality. For example, the SMB protocol has many features directed to printing, however, the driver may not support such printing functionality. Critical functionality, such as directed to setting up a communication session, and the like, are typically supported by the driver.

Game console 100 may load drivers associated with the supported protocols upon startup or power-up of game console 100. Alternatively, game console 100 may load the appropriate driver when a portable computer associated with that driver begins communicating with one of communication ports of game console 100 or at another appropriate time.

Further, the game console 100 may communicate with a personal computer in accordance with the Universal Plug and Play (UPnP) networking architecture and set of network protocols. The Universal Plug and Play networking architecture is a distributed, open networking architecture that may leverage Transmission Control Protocol (TCP), Internet Protocol (IP), and the Web to enable seamless proximity networking for peer-to-peer network connectivity. The Universal Plug and Play set of network protocols are promulgated by the UPnP Forum. Thus, game console 100 may support P, TCP, and Hypertext Protocol (HTTP) in order to provide Universal Plug and Play features.

Universal Plug and Play systems typically utilize IP addressing to allow devices to dynamically join a network and communicate with each other. Some devices in the network are control points, while others are not control points. The first step in Universal Plug and Play networking is called discovery. When a device is added to a network, the device advertises its services to the control points on the network. Similarly, when a control point is added to the network, the control point searches for other devices on the network. The basic exchange in both cases is a discovery message containing a few specifics about the device or one of its services, e.g., its type, identifier, a pointer to more detailed information, and the like. Game console 100 is typically a control point in the network. As a control point in the network, or otherwise, game console 100 may implement a browser to display an indication of the devices on the network.

One feature of Universal Plug and Play networking is called description. After a control point has discovered a device, the control point still knows relatively little about the device. For the control point to learn more about the device and its capabilities, or to interact with the device, the control point retrieves the device's description via, for example, a Universal Resource Locator (URL) provided by the device in the discovery message. The Universal Plug and Play description for a device may be expressed in eXtensible Markup Languauge (XML) and may include vendor-specific, manufacturer information like the model name and number, serial number, manufacturer name, URLs to vendor-specific web sites, etc. The description may include a description of services provided by a device. Game console 100 may include an XML parser. The XML parser, however, may not support all of the features of conventional XML parsers. In order to conserve memory, the XML parser may implement only a subset of the features of conventional XML parsers, and may thus consume less than 1 OK of memory.

Another feature of Universal Plug and Play networking is called control. After a control point has retrieved a description of the device, the control point can send control messages to a device's service, for example, to a control URL for the service (provided in the device description). Control messages may be expressed in XML using the Simple Object Access Protocol (SOAP).

Yet another feature of Universal Plug and Play networking is called event notification, or “eventing.” Event notifications update other devices about the state of a particular device. Event messages may contain the names of one of more state variables and the current value of those variables. The event messages may also expressed in XML and formatted using the General Event Notification Architecture (GENA).

Still another feature of Universal Plug and Play networking is called presentation. If a device has a URL for presentation, then the control point can retrieve a page via this URL, load the page into a browser, and depending on the capabilities of the page, allow a user to control the device and/or view device status. The degree to which each of these can be accomplished depends on the specific capabilities of the presentation page and the device. Game console 100 may include a Universal Plug and Play Renderer to display or render media files stored on the shared folder of the personal computer.

When utilizing the Universal Plug and Play networking protocol, game console 100 is typically a Universal Plug and Play control point. In this manner, the game console 100 may detect and automatically communicate with various personal computers and other devices.

The personal computer may implement the Universal Plug and Play networking protocol via the Windows® Media Connect media distribution service. The Windows® Media Connect service includes a user interface for configuring which folders and directories are shared and which devices are authorized to access content on the personal computer. Windows® Media Connect may also allows users to configure for file sharing only when specific users are logged in, when any user is logged in, or the like.

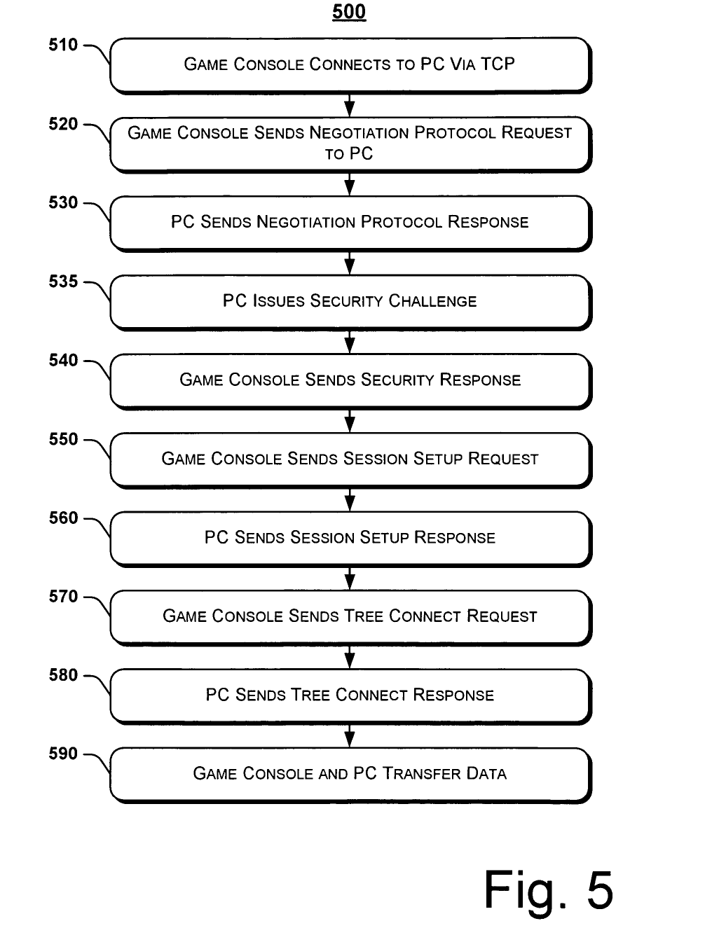

Turning now to specific communications between the game console 100 and the personal computer, FIG. 5 shows an illustrative method 500 for setting up a communication session between game console 100 and a personal computer. As shown in FIG. 5, at step 510, game console 100 connects to the personal computer via TCP, for example, to TCP port 445 of the personal computer.

At step 520, game console 100 sends a negotiation protocol request to the personal computer. For example, game console 100 may send a “SMB_COM_NEGOTIATE” command to the personal computer. Game console 100 may include an indication that game console 100 can communicate via the NT LM 0.12 SMB protocol dialect. While game console 100 may support a variety of SMB protocol dialects or any combination of SMB protocol dialects, game console 100 may also support only a single commonly used SMB protocol dialect, such as the NT LM 0.12 SMB protocol dialect to conserve game console 100 memory.

At step 530, the personal computer receives the request sent at step 520 and sends an appropriate reply command (e.g., “SMB_COM_NEGOTIATE” reply command) to the game console 100. If the reply command indicates that the personal computer can communicate via the NT LM 0.12 SMB protocol dialect (or other dialect supported by the game console 100), processing proceeds to step 535; otherwise, game console 100 and the personal computer may stop the process of communicating with each other.

At step 535, the personal computer sends a security challenge to the game console 100. The security challenge may be any security challenge, such as a security challenge in accordance with an authentication method, such as, for example, Share Level Server Security, LM Challenge/Response Authentication, NTLM Challenge/Response Authentication, and the like.

At step 540, game console 100 receives the security challenge from the personal computer and sends an appropriate security challenge response (e.g., a password). If the security challenge response is a valid response, processing proceeds to step 550; otherwise, game console 100 and the personal computer may stop the process of communicating with each other.

At step 550, game console 100 sends a session setup request command to the personal computer. For example, game console 100 may send a “SMB_COM_SESSION_SETUP_ANDX” command to the personal computer. This command may cause a user login process to occur. The game console 100 may further send a user identification and account password to the personal computer. If the user identification and account password are valid, processing continues to step 560. If the user identification or the account password are not both valid, communication between the game console 100 and the personal computer may stop.

At step 560, the personal computer receives the setup request command sent at step 550 and sends a session setup response to the game console. For example, the personal computer may send an appropriate “SMB_COM_SESSION_SETUP_ANDX” command response to the game console 100.

At step 570, the game console 100 receives the session setup response from the personal computer and sends a tree connect request to the personal computer. For example, game console 100 may send a “SMB_COM_TREE_CONNECT_ANDX” command to the personal computer.

At step 580, the personal computer receives the tree connect request and sends a tree connect response to the game console 100. For example, the personal computer may send an appropriate “SMB_COM_TREE_CONNECT_ANDX” command response to the game console 100, which typically points to a shared folder of the personal computer.

At step 590, the personal computer and game console 100 communicate data, for example, via the shared folder of the personal computer. Any disconnection or termination of communication between the personal computer and the game console 100 may follow conventional SMB protocol techniques for terminating/disconnecting.

The portion of steps 510 through 590 performed by the game console 100 may be implemented via a driver executing in the portion of game console 100 hardware resources reserved for ancillary applications. The driver may be a driver that supports the SMB protocol. The driver may support the entire set of SMB functionality and may support all dialects of the SMB protocol. Alternatively, to conserve hardware resources of game console 100, the driver may support only a subset of SMB functionality. For example, the driver may only support the NT LM 0.12 SMB protocol dialect. Further, the driver may only support the following commands of the NT LM 0.12 SMB protocol dialect: “SMB_COM_CHECK_DIRECTORY,” “SMB_COM_CLOSE,” “SMB_COM_CREATE_DIRECTORY,” “SMB_COM_CREATE_TEMPORARY,” “SMB_COM_DELETE,” “SMB_COM_DELETE_DIRECTORY,” “SMB_COM_FLUSH” “SMB_COM_NEGOTIATE” “SMB_COM_RENAME,” “SMB_COM_SEEK,” “SMB_COM_TREE_CONNECT,” “SMB_COM_TREE_DISCONNECT,” “SMB_COM_COPY,” “SMB_COM_ECHO,” “SMB_COM_LOCKING_ANDX,” “SMB_COM_MOVE,” “SMB_COM_OPEN_ANDX,” “SMB_COM_READ_ANDX,” “SMB_COM_SESSION_SETUP_ANDX,” “SMB_COM_TREE_CONNECT_ANDX,” “SMB_COM_WRITE_ANDX,” “SMB_COM_FIND_CLOSE2,” “SMB_COM_LOGOFF_ANDX,” “SMB_COM_NT_CANCEL,” “SMB_COM_NT_CREATE_ANDX.” In addition, the driver may or may not support file locking commands. Drivers that support file locking commands may be implemented specifically for game developers and studio scenarios. Drivers that do not support file locking commands may be implemented for general purpose gaming consoles. The driver may not support any printing functions. Typically, the driver consumes less than 100K, and possibly less than 60K, of memory to conserve the memory resources of game console 100.

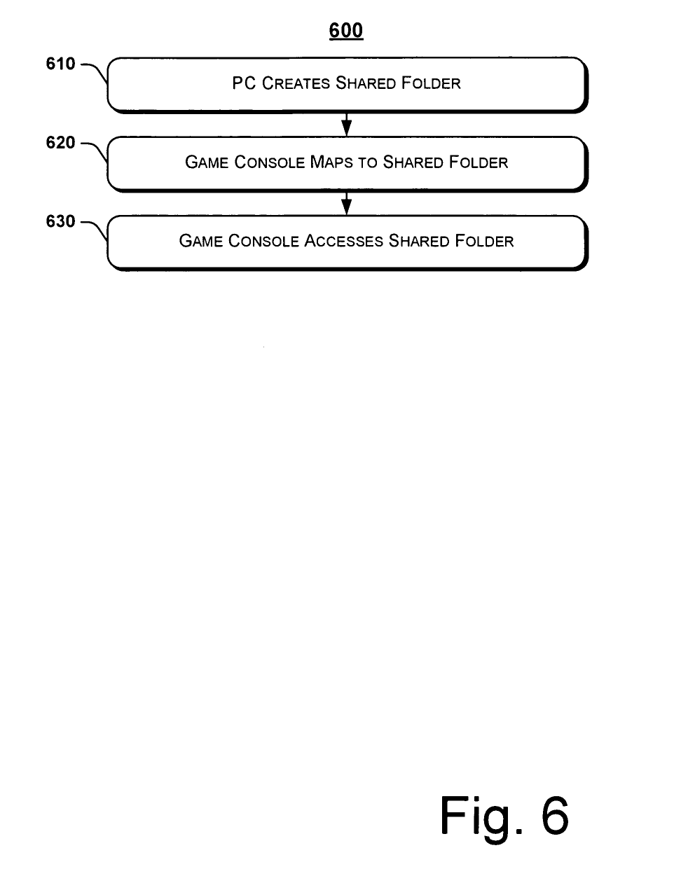

FIG. 6 shows an illustrative method 600 for setting up and accessing a shared folder between a game console and a personal computer. As shown in FIG. 6, at step 610, the personal computer creates a shared folder. The personal computer may implement a user interface (e.g., via a configuration wizard) for a user to input, and personal computer to receive, a name of a shared folder. For example, the personal computer (e.g., named “ComputerName”) may prompt a user to enter a name of a shared folder. The user may enter, for example, “MyGameConsole,” and the personal computer may create a shared folder “C:\MyGameConsole.” Optionally, the shared folder may be associated with one or several users that are authorized to access the shared folder. Further, the shared folder may be associated with one or several devices that are authorized to access the shared folder. Further, if the personal computer is networked, the personal computer may send a SMB_COM_ECHO command to other personal computers in the network to determine if there are other shared folders. As some personal computer operating systems close all ports by default, the configuration wizard (or other configuration application) may also open the appropriate ports for communication between the game console 100 and the personal computer.

At step 620, game console 100 maps to the shared folder of the personal computer. The game console 100 may implement a user interface for a user to input, and game console 100 to receive, the name of the personal computer and the shared folder of the personal computer. For example, the game console 100 may prompt a user to enter the name of the computer and the shared folder. The user may enter, for example, “ComputerName:\C:\MyGameConsole,” and the game console 100 maps to the shared folder of the personal computer. In this manner, the shared folder of the personal computer may appear like any other memory unit of the game console 100. That is, the shared folder may appear in a graphical user interface of the game console 100 like any other memory unit. After such mapping, the user of game console 100 does not have to remember any path or server names.

At step 630, game console 100 accesses the shared folder. Optionally, the personal computer may perform user authentication and device registration prior to allowing the game console 100 to access the shared folder. In this manner, only authorized users on authorized game consoles may access the shared folder. The particular authorization process may depend on the communication protocol being used. For example, when using Universal Plug and Play, the authorization may be implemented with the UpnP MS_DeviceAuthorizationRegistration Service.

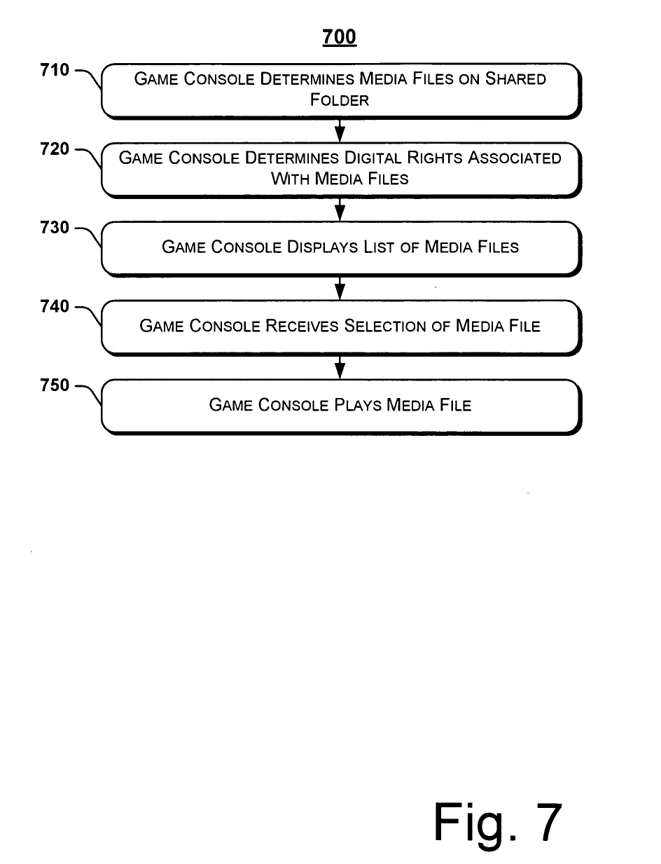

Turning now to some specific examples of accessing the shared folder, FIG. 7 shows an illustrative method 700 for game console 100 to communicate with a personal computer. As shown in FIG. 7, at step 710, an ancillary application (or the primary application, game application, multimedia application, or other application) of game console 100 communicates (e.g., via a session setup such as in FIG. 5) with the personal computer and determines the media (e.g., files, and the like) on the shared folder of the personal computer. For example, game console 100 may read from the shared folder (possibly including all of the sub-directories of the shared folder) of the personal computer and determine that one of the sub-directory's of the shared folder is storing ten digital photographs in the Joint Photographic Expert Group (JPEG) format (i.e., ten JPEG files). In the case of a networked system of personal computers (e.g., FIG. 3), the personal computer may require an appropriate username and password (i.e., entered by the user at the game console 100 possibly via the game console graphical user interface) before proceeding with step 710. Further, if there are multiple networked personal computers, the game console 100 may prompt for an identification of a particular personal computer before proceeding with step 710. This identification may be required each time a user starts game console 100 or once a particular personal computer is selected it may be associated with that game console 100 in the future.

At optional step 720, game console 100 may determine the digital rights associated with the media files determined at step 710. For example, game console 100 may determine that there are no digital rights associated with the ten JPEG files stored in the shared folder of the personal computer. In such a case, game console 100 may proceed directly to step 540. Alternatively, game console 100 may determine that there are some digital rights associated with the media stored in the shared folder of the personal computer. In such a case, game console 100 may not proceed directly to step 730, but may instead end any processing associated with the personal computer, may allow the user to only view metadata associated with the media files (e.g., the names of the media files), may allow the user to access (“play”) the media files but not forward or copy the media files, and the like.

At step 730, game console 100 displays a list of the media files stored in the shared folder (possibly including all of its sub-directories) of personal computer, on the user interface associated with game console 100 (e.g., on a television via A/V port 140). For example, game console 100 may display a list of the names of the ten JPEG files found in the shared folder. Game console 100 may start an ancillary application that interfaces with the user and determines how the user wishes to interact with the media files. The ancillary application typically runs within the processing time left over from the processing time dedicated to the gaming application. If, however, no gaming application is executing, the ancillary application may be the only application running, and thus may not be restricted in its execution. In such a case, upon execution of a gaming application, the ancillary application may be stopped and the gaming application may then execute using its normally dedicated resources.

At step 740, the ancillary application (e.g., via game controller 190 or other input device), receives a selection from a user for a particular media file stored in the shared folder For example, using game controller 190, a user may input and game console 100 may receive a selection of the first of the ten JPEG files in the shared folder. Further, using game controller 190, the user may input and game console 100 may receive a selection to display each of the ten JPEG files in the shared folder consecutively as a slide show.

At step 750, game console 100 plays the selected media file or files. Game console 100 may convert the selected media file from its existing format (e.g., JPEG format) into an appropriate format for display or rendering via the audio/visual port 140. For example, game console 100 (via the ancillary application) may convert the first of the ten JPEG files in the shared folder into a format compatible with display or rendering via the audio/visual port 140 and then display the media associated with the media file on a display device (e.g., a television via the A/V port 140). Game console 100 may play the selected media file by first copying the file from the shared folder to memory 112 or media drive 144 and then playing the media file from memory 112 or media drive 144. Alternatively, game console 100 may play the selected media file by streaming the media file from the shared folder of the personal computer to the game console 100. The media file may be streamed via HTTP Streaming.

Game console 100 may execute steps 710 through 750 while the game application is executing. In such a case, steps 710 through 750 are typically executed within the processing time and resources that are not dedicated to the gaming application. If, however, no game application is executing, the ancillary application may execute using any of the hardware resources of game console 100.

The method 700 of FIG. 7 enables a variety of user choices for playing media files. For example, a user may take vacation pictures on their digital camera and then store them onto a personal computer. Then, the user can show their vacation pictures on a large screen television display instead of a small camera display or a personal computer screen. The game console 100 may display (e.g., on a large screen or plasma screen television) a list of the digital pictures on the shared drive (possibly along with small versions of the images) and allow the user to select particular digital pictures or to select showing all of the digital pictures in a slide show format. In this manner, a user can use the user-friendly interface of game console 100 instead of the digital camera user interface or the personal computer. Further, the game console 100 may display digital pictures stored on multiple networked personal computer, such as in a home network.

Also, a user may store audio (e.g., music) and video files onto their personal computer and play the music via game console 100. Game console 100 may display a music visualizer (e.g., on a television via A/V port 140) based on the music and thus, provide a much more interesting listening experience. The graphical user interface of the game console 100 may display the audio files on the shared folder of the personal computer and allow the user to select audio files for rendering. With multiple networked personal computers, the graphical user interface may display the audio and video files on all of the shared folders of the networked personal computers and may integrate the files into a single list (with no repeats, even if the same song is on multiple shared folders).

Additionally, a user may decide that they are tired of listening to the soundtrack of a particular game application and may then download a group of songs onto the shared drive of their personal computer. Then, the user can display a soundtrack menu that includes audio files found on the shared drive of the personal computer (or multiple networked personal computers). The user can then select a particular song or group of songs and game console 100 plays the user's song selection instead of the game application's default song as the game application's soundtrack. Alternatively, a user may use game console 100 to play songs on the shared drive without playing any game application on game console 100.

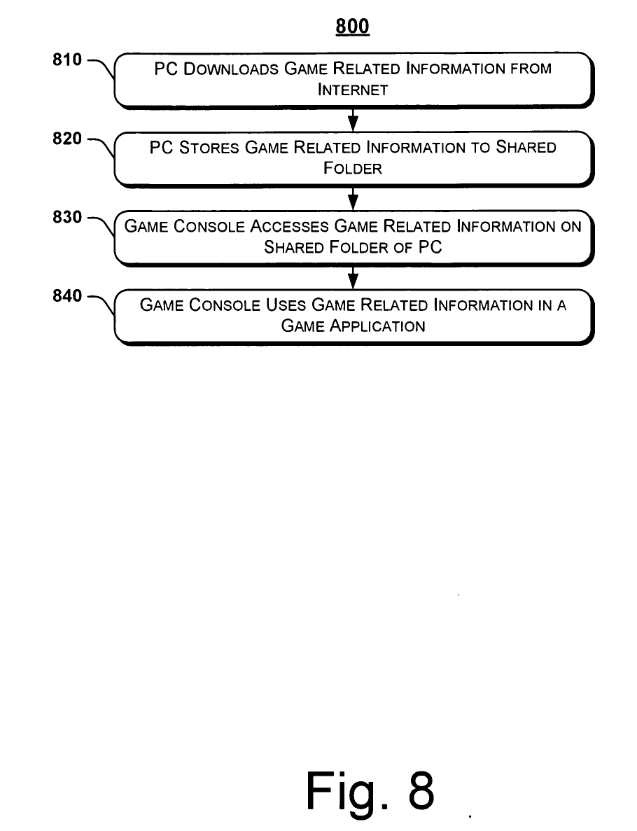

In addition to using the shared folder for storing media files, the shared folder may further store game-related information. The game-related information can originate from a variety of sources. FIG. 8 shows an illustrative method 800 for game console 100 to communicate game-related information (e.g., downloaded from the Internet) with a personal computer. As shown in FIG. 8, at step 810, a user downloads game-related information via the Internet to the personal computer. The game-related information may include, for example, a game-clip (also referred to as a “ghost race”, a “highlight”, a “highlight race”, or a “saved game”), a game demo, gaming configuration data, a configuration setting, such as, a “left handed” game controller 190 configuration, a team icon, a custom playbook/roster, a player emblem, a log of last played games, customization, a racing game suspension setting, a racing game bike model or color, a racing game suit color, a weather condition for a game, and the like. The game-related information may also include game developer generated information. For example, a game developer may post weather conditions for a football game to a website for later downloading by game console users.

At step 820, the personal computer stores the game-related information to the shared folder of the personal computer. For example, the personal computer may store the game-related information (e.g., a team icon) to the shared folder “MyGameConsoleFolder.”

At step 830, game console 100 accesses the game-related information on the shared folder. For example, game console 100 may use an SMB compatible code to read the team icon from the shared folder “MyGameConsoleFolder.” Game console 100 may access the game-related information via a game application (because the shared folder appears to the game console 100 as just another accessible memory device); however, an ancillary application of game console 100 may access the shared folder for various uses of the game-related information.

At step 840, the game application of game console 100 uses the game-related information in the game application. For example, the game application may use the team icon in displaying particular screens of the game application.

The method 800 of FIG. 8 enables a variety of user choices for including various game-related information from various sources into their game applications. For example, a user may download a small executable game file (e.g., a file that executes on the game console 100 but not on the personal computer) from the Internet to the shared folder of the personal computer. The user may then run the small executable game file on the game console 100 by accessing the shared folder of the personal computer. If the personal computer is networked, the executable game file may be shared by multiple users. To prevent unauthorized sharing, the executable file may be digitally signed.

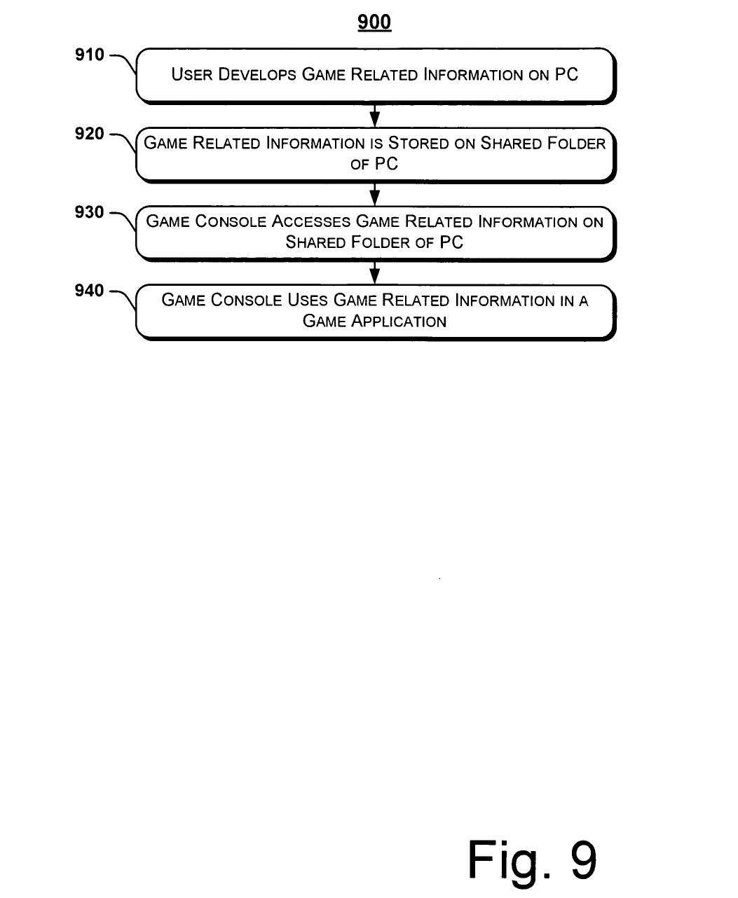

FIG. 9 shows an illustrative method 900 for game console 100 to communicate game-related information (e.g., created at a personal computer) with the personal computer. As shown in FIG. 9, at step 910, a user creates game-related information one their personal computer. The game-related information may include, for example, a game demo, gaming configuration data, a configuration setting, such as, an “inverted” game controller 190 configuration, a “left handed” game controller 190 configuration, a team icon, a custom playbook/roster, a player emblem, customization, a racing game suspension setting, a racing game bike model or color, a racing game suit color, and the like. While some game-related information may be generated using conventional personal computer applications (e.g., creating a team emblem with a drawing program), other game-related information may be created utilizing a personal computer application that emulates the functionality of the game console 100. For example, if there is no conventional personal computer application for configuration of a game controller 190, a special application may be provided that emulates the configuration of game controller 190 and stores the configuration on the shared folder.

At step 920, the personal computer stores the game-related information to the shared folder of the personal computer. For example, the personal computer may store the game-related information (e.g., a team icon) to the shared folder “MyGameConsoleFolder.”

At step 930, game console 100 accesses the game-related information on the shared folder. For example, game console 100 may use an SMB driver to read the team icon from the shared folder “MyGameConsoleFolder.” Game console 100 may access the game-related information via a game application (because the shared folder appears to the game console 100 as just another accessible memory device); however, an ancillary application (or the primary application, game application, multimedia application, or other application) of game console 100 may access the shared folder for some other uses of the game-related information.

At step 940, the game application of game console 100 uses the game-related information in the game application. For example, the game application may use the team icon in displaying particular screens of the game application.

The method 900 of FIG. 9 enables a variety of user choices for including various game-related information from various sources into their game applications. For example, a user may create a custom team icon for a game application (e.g., using a drawing application on a personal computer). The custom team icon may then be saved to the shared folder. Then, the user can select that custom team icon from their shared folder and the game application may display the custom team icon instead of the game supplied icons. Further, the user may custom develop a relatively small game application on the personal computer and then access the custom developed game from the game console 100 for execution. Moreover, a parent could configure parental control configuration settings for the game console 100 and store the settings on the shared folder of the personal computer. The parental control settings could then be read by the game console 100 before playing any particular game application to determine if the game application can be played.

As a specific example, a boxing game application may allow users to select a face for one of the boxers in the game. With the method of FIG. 9, a user can create a face image to be used in the boxing game application and save the image to the shared folder of the personal computer. Once the game console 100 is mapped to the shared folder, when game console 100 displays the images available as faces, it not only displays the images on the game console 100, but also the images on the shared folder.

Moreover, a user may create an image to be used as a digital identity. In this manner, the created image is displayed next to the user's name in friend's lists, in-game player's lists, and the like. Further, some game applications include the ability for user's to create their own content for games. Such games are typically labeled with and “Extensible Game” logo. With such games, the game DVD can be inserted into the DVD of a personal computer, which installs a game application specific tool. The user can use the tool to create a new game level, then transfer the new game level to the game console 100, via the shared folder. The user can further save the new game level to a website and download other new game levels (e.g., created by other users) to the shared folder of the personal computer.

Such creation of game-related information at a personal computer may also be useful to game developers. For example, a game developer may want to test some code written at a personal computer. The game developer may create a shared folder on the personal computer and may store an executable game file on the shared folder. In this manner, the game developer may run an executable game file on the game console 100, directly from the shared folder of the personal computer. While the network latency may make the executable run a little slower, the speed may not be that important to a game developer. Moreover, game developers may store common artwork on a shared folder for use in game application development. Further, if a game application is executing on a game console 100, and the game console 100 is directed to the shared folder, a game developer may modify or add files (on the shared folder) while the game application is executing. Such changes would be effective the next time the game application accesses the modified or new files.

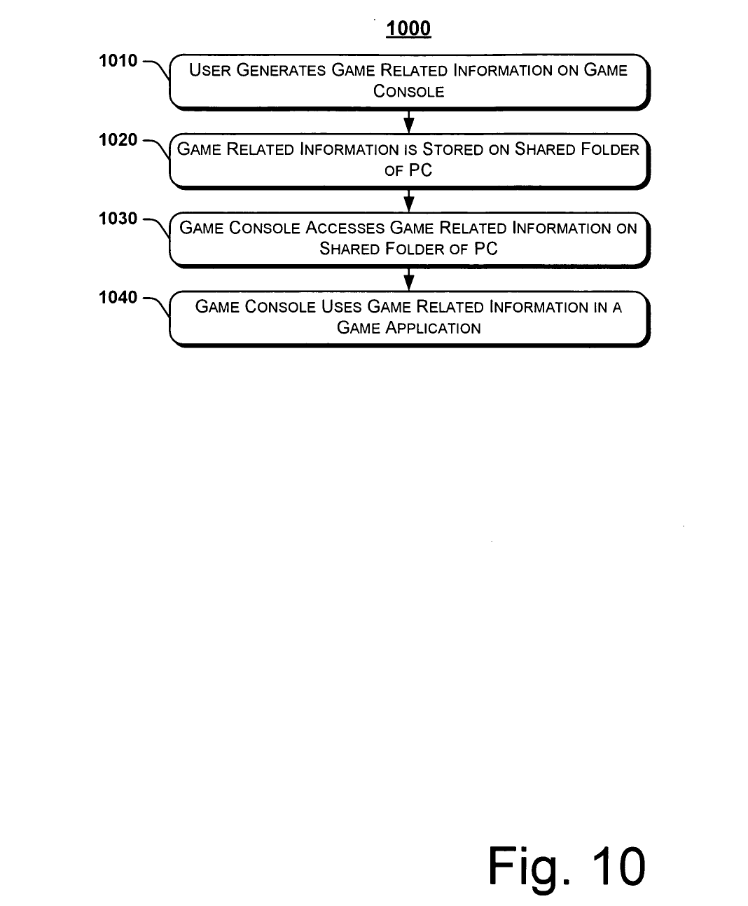

FIG. 10 shows an illustrative method 1000 for game console 100 to communicate game-related information (e.g., generated at the game console 100) with the personal computer. As shown in FIG. 10, at step 1010, a user creates game-related information one their game console 100. The game-related information may include, for example, a game-clip (also referred to as a “ghost race”, a “highlight”, a “highlight race”, or a “saved game”), a game demo, gaming configuration data, a configuration setting, such as, an “inverted” game controller 190 configuration, a “left handed” game controller 190 configuration, a racing game suspension setting, a racing game bike model or color, a racing game suit color, and the like.

At step 1020, the personal computer stores the game-related information to the shared folder of the personal computer. For example, the personal computer may store the game-related information (e.g., a saved game) to the shared folder “MyGameConsoleFolder.” Further, the game-related information may be stored to multiple locations dynamically. For example, the game-related information may be stored to the personal computers of a group of friends whose personal computers are connected to a dormitory subnet.

At step 1030, game console 100 accesses the game-related information on the shared folder. For example, game console 100 may use an SMB driver to read the saved game from the shared folder “MyGameConsoleFolder.” Game console 100 may access the game-related information via a game application (because the shared folder appears to the game console 100 as just another accessible memory device); however, an ancillary application of game console 100 may access the shared folder for some other uses of the game-related information.

At step 1040, the game application of game console 100 uses the game-related information in the game application. For example, the game application may use the saved game to start playing a game application from the saved portion of the saved game, instead of at the beginning of a game.

The method 1000 of FIG. 10 enables a variety of user choices for storing game-related information to their personal computer. For example, a user may save a game as a saved game in the shared folder of the personal computer. If the personal computer is networked, for example, on a subnet, other game consoles 100 may read the saved game from the shared folder. In this manner, a user of game console 100 may share saved games (as well as other game-related information) with other game console users, such as other users on a dormitory subnet. Moreover, once a game-related information is saved to the shared folder of the personal computer, the game-related information may be emailed to other users (e.g., as an attachment to an email message). Further, the game-related information may be downloaded from the Internet directly to the game console 100. That is, on a Internet compatible game console 100, a user may download from the Internet weather conditions for a particular game application and then save those weather conditions to the shared folder of the personal computer.

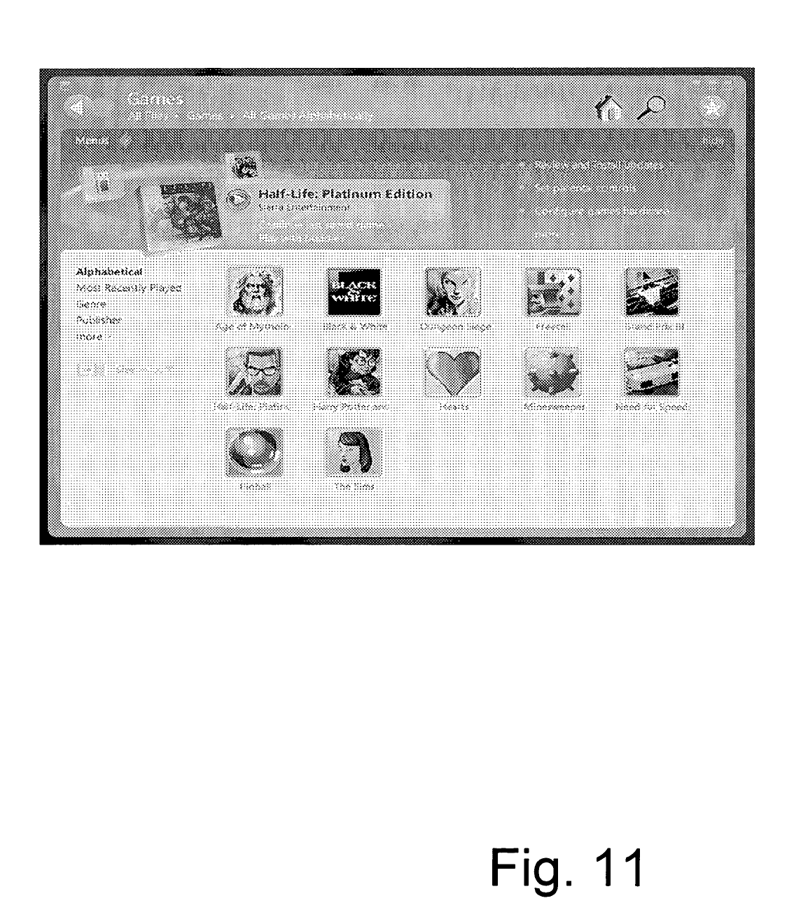

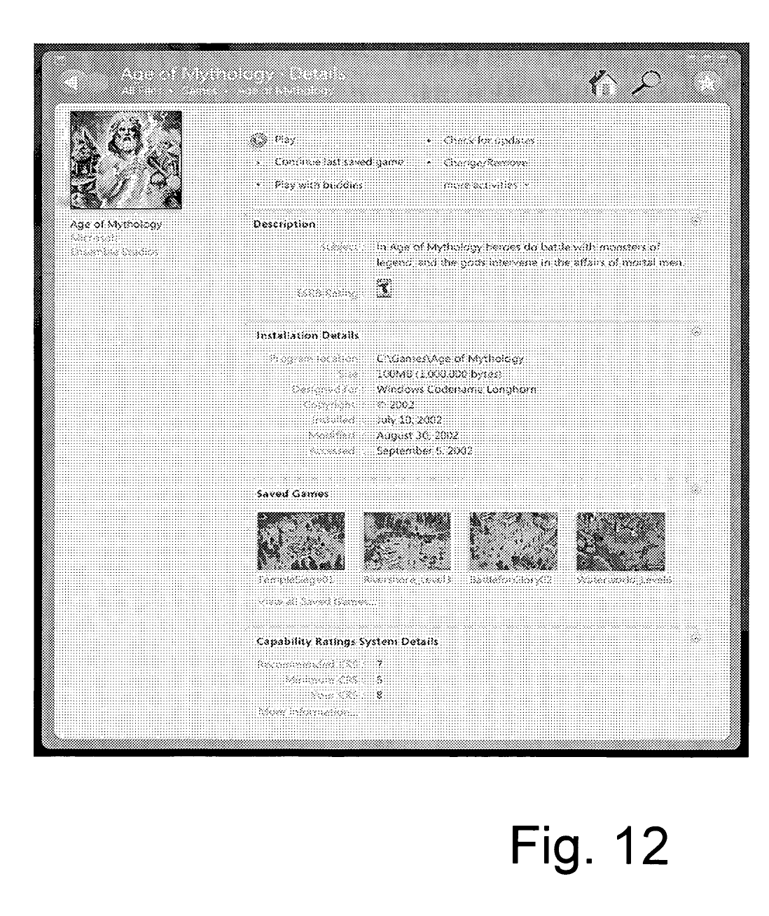

The methods of FIGS. 6 through 10 may be presented to the user in a comprehensive user interface. Such illustrative user interfaces are shown in FIGS. 11 and 12. As shown in FIG. 11, a menu of options is displayed, such as, “Review and install updates,” “Set Parental Controls,” and “Configure game hardware.” Upon selection of an option, the user interface may walk the user through the various steps involved in implementing that option. Further, each game application has an associated icon which can be selected to provide more details about that game application and its associated game-related information on the shared drive. FIG. 12 shows an illustrative user interface showing additional information about a particular game application, showing the saved games, the location of the game, and the like. The user interface can also provide user access to game chat rooms and the like.

Aspects of the invention may be implemented via computer storage media and communication media. Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

Communication media typically embodies computer readable instructions, data structures, program modules, or other data in a modulated data signal, such as carrier wave or other transport mechanism. Communication media also includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It should be noted that although the game console discussed herein is described as a dedicated game console (not a general-purpose PC running computer games), the game console may also incorporate additional functionality. For example, the game console may be a multimedia console and may include digital video recording functionality so that it can operate as a digital VCR, the game console may include channel tuning functionality so that it can tune and decode television signals (whether they be broadcast signals, cable signals, satellite signals, etc.), and so forth. Further, in alternate embodiments, the game console is replaced with a set top box or other computing device.

As the foregoing illustrates, the invention is directed to game console communication with a computer. It is understood that changes may be made to the illustrative embodiments described above without departing from the broad inventive concepts disclosed herein. Accordingly, it is understood that the invention is not limited to the particular embodiments disclosed, but is intended to cover all modifications that are within the spirit and scope of the invention as defined by the appended claims.

What is claimed:

1. A method for communication between a game console and a personal computer, the method comprising:
accessing, from a game console, a shared folder of a personal computer, the shared folder being shared by the game console and the personal computer; and
communicating a file between the shared folder of the personal computer and the game console.

2. The method as recited in claim 1, wherein communicating the file from the shared folder comprises copying the file from the shared folder of the personal computer to the game console.

3. The method as recited in claim 1, wherein communicating the file from the shared folder comprises streaming the file from the shared folder of the personal computer to the game console.

4. The method as recited in claim 1, wherein communicating the file comprises communicating the file from the shared folder of the personal computer to the game console via a Server Message Block Protocol compatible code.

5. The method as recited in claim 4, wherein the Server Message Block Protocol compatible code supports only a subset of the Server Message Block Protocol features.

6. The method as recited in claim 1, wherein communicating the file comprises one of writing a game-related information file to the personal computer and receiving a game-related information file from the personal computer.

7. The method as recited in claim 6, wherein the game-related information file comprises a game controller configuration file.

8. The method as recited in claim 6, wherein the game-related information file comprises a game application configuration file.

9. The method as recited in claim 6, wherein the game-related information file comprises a game application parental control configuration file.

10. The method as recited in claim 1, wherein communicating the file comprises receiving a game-related information file from the personal computer and wherein the game-related information file originated from the Internet and further comprising using, at the game console, the game-related information file in executing a game application on the game console.

11. The method as recited in claim 1, wherein communicating the file comprises receiving a game-related information file from the personal computer and wherein the game-related information file originated from the personal computer and further comprising using, at the game console, the game-related information file in executing a game application on the game console.

12. The method as recited in claim 1, further comprising:
generating, at the game console, a game-related information file;
saving, from the game console to the shared folder of the personal computer, the game-related information file;
retrieving, to the game console from the shared folder of the personal computer, the game-related information file; and
using, at the game console, the retrieved game-related information file in executing a game application on the game console.

13. The method as recited in claim 1, further comprising:
generating, at the game console, a game-related information file;
saving, from the game console to the shared folder of the personal computer, the game-related information file;
retrieving, from the shared folder of the personal computer to a second game console networked to the personal computer, the game-related information file; and
using, at the second game console, the retrieved game-related information file in executing a game application on the second game console.

14. The method as recited in claim 1, further comprising networking the game console to the personal computer via a Universal Plug and Play networking protocol wherein the game console functions as a Universal Plug and Play networking protocol control point.

15. The method as recited in claim 1, further comprising networking the game console to the personal computer via a subnet.

16. The method as recited in claim 1, further comprising mapping the shared folder of the personal computer to the game console and displaying the shared folder as another memory unit of the game console.

17. The method as recited in claim 1, further comprising:
displaying a user interface that prompts the user for a computer name;
receiving a computer name from the user interface; and
mapping to a computer having the received computer name over a network connection.

18. The method as recited in claim 1, further comprising:
determining a media file stored on the shared folder of the personal computer;
writing an indication of the media file to an audio/visual port for display on a display device;
receiving a user selection of the media file; and
playing the selected media file.

19. The method as recited in claim 18, wherein playing the selected media file comprises playing a slide show of digital photographs.

20. The method as recited in claim 18, further comprising copying the selected media file to the game console prior to playing the selected media file.

21. The method as recited in claim 18, further comprising streaming the selected media file to the game console.

22. The method as recited in claim 18, wherein the selected media file comprises a digital photograph and playing the selected media file comprises:
converting the selected media file to a format compatible with display via an audio/visual port; and
writing the converted media file to the audio/visual port for display on a display device.

23. The method as recited in claim 18, wherein the selected media file comprises an audio file and playing the selected media file comprises:
converting the selected media file to a format compatible with rendering via an audio/visual port; and
writing the converted media file to the audio/visual port for an audio device.

24. A method for communication between a game console and a personal computer, the method comprising:
reserving a predetermined amount of hardware resources of a game console for executing a game application;
executing the game application substantially using the predetermined amount of reserved hardware resources; and
concurrently executing an ancillary application substantially using the remaining hardware resources, the ancillary application causing communication between the game console and a shared folder of a personal computer.

25. The method as recited in claim 24, wherein reserving the predetermined amount of hardware resources comprises reserving a predetermined amount of memory for the game application.

26. The method as recited in claim 24, wherein reserving the predetermined amount of hardware resources comprises reserving a portion of central processing unit time for the game application.

27. The method as recited in claim 24, wherein causing communication between the game console and a shared folder of a personal computer comprises one of copying the file from the shared folder of the personal computer to the game console and streaming the file from the shared folder of the personal computer to the game console.

28. The method as recited in claim 24, wherein causing communication between the game console and a shared folder of a personal computer comprises communicating the file from the shared folder of the personal to the game console via a Server Message Block Protocol compatible code.

29. The method as recited in claim 28, wherein the driver compatible with the Server Message Block Protocol does not support a full set of Server Message Block Protocol features.

30. The method as recited in claim 24, further comprising networking the game console to the personal computer via a Universal Plug and Play networking protocol wherein the game console functions as a Universal Plug and Play networking protocol control point.

31. The method as recited in claim 24, wherein causing communication comprises one of writing a game-related information file to the personal computer and receiving a game-related information file from the personal computer.

32. The method as recited in claim 24, wherein the ancillary application further causes receiving a game-related information file from the personal computer and wherein the game-related information file originated from the Internet and further comprising using, at the game console, the game-related information file in executing a game application on the game console.

33. The method as recited in claim 24, wherein the ancillary application further causes receiving a game-related information file from the personal computer and wherein the game-related information file originated from the personal computer and further comprising using, at the game console, the game-related information file in executing a game application on the game console.

34. The method as recited in claim 24, further comprising:
generating, at the game console, a game-related information file;
saving, from the game console to the shared folder of the personal computer, the game-related information file;
retrieving, to the game console from the shared folder of the personal computer, the game-related information file; and
using, at the game console, the retrieved game-related information file in executing a game application on the game console.

35. The method as recited in claim 24, further comprising:
determining a media file stored on the portable device;
writing an indication of the media file to an audio/visual port for display on a display device;
receiving a user selection of the media file; and
playing the selected media file.

36. The method as recited in claim 24, further comprising reserving a second predetermined amount of memory for facilitating communication between the game application and the ancillary application.

37. The method as recited in claim 24, further comprising sharing an input device between the game application and the ancillary application.

38. A game console, comprising:
a central processing unit having a portion of its resources reserved for executing a game application;
a communication controller having an associated port, the communication controller in communication with the central processing unit;
a memory in communication with the central processing unit, the memory having a first portion of resources reserved for executing the game application and a second portion of resources reserved for executing an ancillary application to communicate, via the communication controller port, with a shared folder of a personal computer.

39. The game console as recited in claim 38, wherein the memory further has a third portion of resources reserved for communication between the game application and the ancillary application.

40. The game console as recited in claim 38, wherein the memory executes computer-readable code that networks the game console to the personal computer via a Universal Plug and Play networking protocol and wherein the game console functions as a Universal Plug and Play networking protocol control point.

41. The game console as recited in claim 38, wherein the memory executes computer-readable code that communicates between the shared folder of the personal computer and the game console via a Server Message Block Protocol compatible code.

42. The game console as recited in claim 41, wherein the Server Message Block Protocol compatible code supports only a subset of the Server Message Block Protocol features.

43. The game console as recited in claim 38, wherein the memory executes computer-readable code that communicates between the shared folder of the personal computer and the game console via a subnet.

44. The game console as recited in claim 38, wherein the memory executes computer-readable code that maps the shared folder of the personal computer to the game console and displays the shared folder as another memory unit of the game console.

45. The game console as recited in claim 38, wherein the memory executes computer-readable code that:
displays a user interface that prompts the user for a computer name;
receives a computer name from the user interface; and
maps to a computer having the received computer name over a network connection.

46. The game console as recited in claim 38, wherein the memory executes computer-readable code that:
determines a media file stored on the shared folder of the personal computer;
writes an indication of the media file to an audio/visual port for display on a display device;
receives a user selection of the media file; and
plays the selected media file.
